(19) United States
(12) Patent Application Publication
(10) Pub. No.: US 2013/0291293 A1
(43) Pub. Date: Nov. 7, 2013

(54) Integrated Stretch Padded Laminate and Footwear

(71) Applicants: Alexander W. Jessiman, Kennett Square, PA (US); Robert William, JR., Port Deposit, MD (US); Andrea Giupponi, Fiesso d' Artico (IT)

(72) Inventors: Alexander W. Jessiman, Kennett Square, PA (US); Robert William, JR., Port Deposit, MD (US); Andrea Giupponi, Fiesso d' Artico (IT)

(21) Appl. No.: 13/463,947

(22) Filed: May 4, 2012

(51) Int. Cl. A43B 23/26; A41D 19/00; A41D 1/06; A43B 17/00; D04H 13/00; A41D 13/06; A41D 13/05; A43B 1/00; B32B 5/32; A41D 27/26; A43B 23/00

(52) U.S. Cl. 2/459; 36/54; 2/159; 2/228; 2/239; 36/45; 2/24; 2/16; 36/83; 428/316.6; 442/304; 442/327

(57) ABSTRACT

Waterproof, breathable, stretch-recoverable composites are described herein. They are utilizable within footwear assemblies and exhibit stretchability in at least one direction by at least about 35% at 4 lbs force and exhibit at least about 80% recovery. The composites also exhibit a minimum compression of about 1 mm under a 10 kPa load and recovery of at least about 90% when load is removed.

### BACKGROUND

Protective clothing articles used for wear in wet conditions (such as rain, snow, etc.); in outdoor activities (such as skiing, biking, hiking, etc.); in handling hazardous chemicals, in preventing contamination, in avoiding infection, should in each instance protect the wearer by preventing leakage of water or other fluids into the article while keeping the wearer comfortable by allowing perspiration to evaporate from the wearer to the outside of the article. In addition, if such an article is intended to be reusable, it should maintain the functional attributes of protection and comfort during ordinary use.

In protective clothing articles where flexibility of movement is essential, stretchable fabric laminates with the above functional attributes are needed along with soft and drapeable feeling. Such stretchable fabric laminates are increasingly being used to make protective clothing articles which are form-fitting since the stretch properties of the material allow for a closer fit without adversely affecting the wearer's comfort, Gloves, footwear, mittens, socks, stockings, ski wear, running suits, athletic garments, medical compresses, are some examples of such articles of protective clothing requiring form-fitting characteristics.

In addition to the above, the direction or directions of stretch, the amount of stretch and its recovery and the force exerted during recovery are all important properties that determine comfort of form-fitting articles of protective clothing as well as the method and ease of manufacturing them. The precise magnitude and balance of these properties in a stretchable fabric material, however, depend on each specific end use.

A variety of attempts have been made to improve stretchable, breathable laminated and composite fabrics. Although, improvements have been made, many of these fabrics obtain varying degrees of waterproofness, breathability, stretch, stretch-recovery, and comfort. Further, many fabrics sacrifice may sacrifice one or more qualities to improve upon other qualities.

Thus, there remains a need for a composite that achieves a high degree of waterproofness, breathability, stretch-recovery, padding, and comfort by in use within a variety of applications, including footwear.

### SUMMARY OF INVENTION

A waterproof, breathable stretch recoverable composite and a footwear assembly that includes the composite are described herein. The composite includes a first layer having a waterproof breathable film. The composite also includes a second layer having a breathable padding material attached to the first layer. The composite is stretchable in at least one direction by at least about 35% at 4 lbs force and exhibit at least about 80% recovery. The composite also exhibits a minimum compression of about 1 mm with a 10 kPa load and a recovery of at least about 90% when the load is removed.

The breathable padding material may be foam, fleece, three dimensional knit, nonwoven materials, or the like. The film may be a polymeric film, such as polyurethane of polytetrafluoroethylene, and may be thermoplastic or elastomeric. The composite has a breathability of at least about 600 g/m²/day.

In alternative embodiments, the composite may contain an additional textile layer or layers 40 and/or an additional film layer or layers. The composite may be utilized as a shoulder pad, glove, bike short, bootie, shoe quarter, shoe upper component such a shoe tongue, knee pad, or elbow pad. When utilized as a shoe tongue, quarter, or other upper component, the composite is substantially gussettless. That is, the composite does not require a gusset—extra material to allow the item to be donned and doffed while maintaining waterproofness. The excess material of a gusset would then exist as folds during wearing after donning. These folds can potentially adversely affect fit and comfort of the wearer.

A footwear assembly for forming at least a part of footwear is also provided herein. The footwear assembly includes a first peripheral construction adapted to surround at least a portion of a foot. The peripheral section is the section of footwear assembly not located in a section where a shoe tongue is located, and in embodiments, is also substantially gussetless. The footwear assembly also includes a composite comprising a tongue construction which projects over an opening of the footwear adapted for insertion of a foot. The tongue construction includes a first layer having a waterproof breathable film and a second layer having a breathable padding material attached to the first layer. The tongue construction may be connected with the first peripheral construction utilizing stitched seam, an adhesive, or any other effective method.

The tongue exhibits the performance properties and may be composed of the materials described above for breathable padding materials.

In use, the breathable padding material is arranged on a surface of the waterproof breathable film facing towards an inside surface of the footwear. The breathable padding material may also further include a backing layer arranged on a surface of the waterproof breathable film facing outside of the footwear, and a lining layer facing towards an inside of the footwear, wherein the waterproof breathable film is disposed between the backing layer and lining layer.

In another embodiment, a footwear assembly for forming at least a part of footwear is provided. The footwear assembly includes a first peripheral construction having one or more sections and adapted to surround at least a portion of a foot. It also includes a tongue construction. At least one section of the first peripheral construction includes a composite having a first layer having a waterproof breathable film and a second layer having a breathable padding material attached to the first layer.

### BRIEF DESCRIPTION OF DRAWINGS

FIG. 1 is a perspective view of a waterproof, breathable, stretch recoverable composite having a film and padding material layer.

FIG. 2 is a perspective view of a multilayer waterproof, breathable, stretch recoverable composite having a plurality of composites including film and fabric; and having a padding material layer.

FIG. 3 is a perspective view of a footwear assembly having a tongue construction that includes a composite of at least foam and film.

FIG. 4 is a perspective view of a footwear assembly that includes a waterproof, breathable, stretch recoverable composite located in a quarter section of the footwear assembly.

### DETAILED DESCRIPTION

The present invention provides for waterproof, breathable, stretch-recoverable composites and footwear assemblies incorporating them therein.

The invention will be described with reference to the following description and figures which illustrate certain embodiments. It will be apparent to those skilled in the art that these embodiments do not represent the full scope of the invention which is broadly applicable in the form of variations and equivalents as may be embraced by the claims appended hereto. Furthermore, features described or illustrated as part of one embodiment may be used with another embodiment to yield still a further embodiment. It is intended that the scope of the claims extend to all such variations and embodiments.

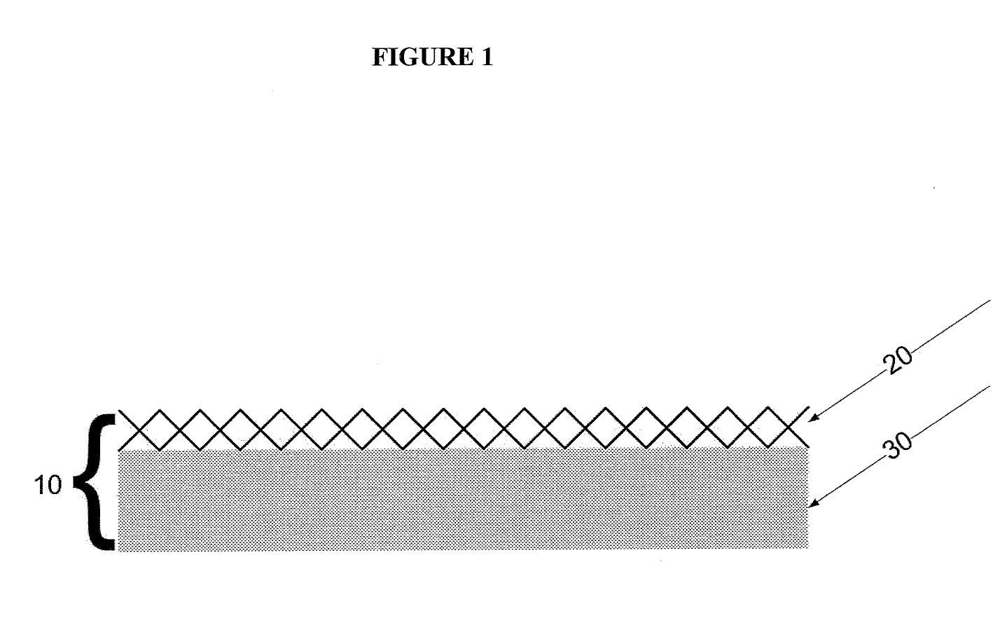

Turning to FIG. 1, a perspective view of a waterproof, breathable, stretch recoverable composite 10 having a film 20 and padding material layer 30 is provided. The film may be selected from polyurethane, polyester, polyether, polyamide, polyacrylate, copolyether ester and copolyether amides, as well as other suitable thermoplastic and elastomeric films. In an aspect of the invention the waterproof, water vapor permeable membrane is a membrane of microporous polytetrafluoroethylene. In a further aspect of the invention, the microporous polytetrafluoroethylene membrane is a membrane of expanded polytetrafluoroethylene as taught in U.S. Pat. Nos. 3,953,566 and 4,187,390, to Gore. Such membranes of expanded polytetrafluoroethylene are present in commercially available laminates from W. L. Gore and Associates, Inc., Elkton, Md., under the tradename GORE-TEX® fabric.

The padding material layer may be selected from foam, fleece, wovens, film, three dimensional knit or nonwoven material. Suitable three dimensional knit include a variety of spacer fabrics, including weft knit, and warp knit, and raschel, flat, or circular knit spacer fabrics. Suitable nonwoven materials include felt, wadding, stretch spunbond nonwovens, stretch needlepunched non wovens, and stretch spunlace non-wovens, etc.

The film may be joined to the padding material layer by a number of suitable mechanisms. These include stitching, sewing, gluing, ultrasonic bonding, radio frequency welding, flamebonding, heat sealing etc. In an embodiment, polyurethane is utilized to join the film with the padding layer. Polyurethane adhesive in a discontinuous dot pattern is a desirable embodiment.

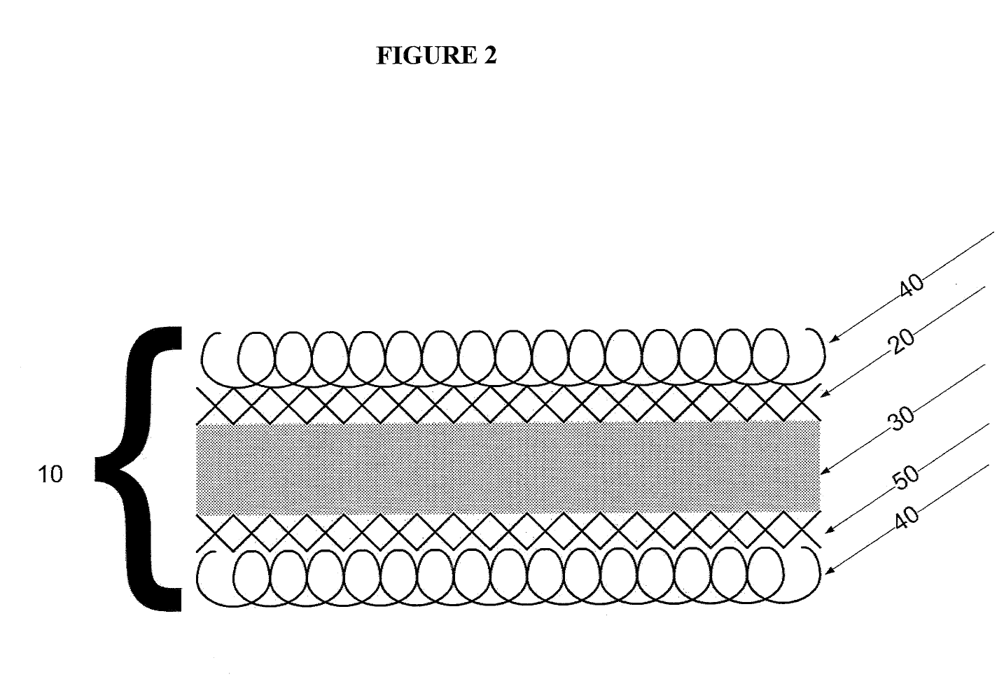

Turning to FIG. 2, the composite 10 may comprise additional layers. The illustrated composite includes an additional film layer 50 as well as 2 additional textile layers 40. The composite, however, may contain any number of additional layers as long as it meets certain performance properties later described herein. The additional layers may be attached to the composite utilizing any of the mechanisms previously described, as well as needlepunching additional layers to the breathable padded layer.

Regardless of the type of film and padding layer utilized, number of additional layers, or mechanism for bonding the material together, the composite, desirably, will contain certain properties. For example, the composite will have a breathability of at least 600 g/m²/day, desirably at least 1000 g/m²/day, more desirably at least 1500 g/m²/day, and even more desirably at least 2000 g/m²/day.

Additionally, the composite is stretchable in at least one direction by at least about 35% at 4 lbs force, more desirably at least 50% and exhibit at least about 80% recovery, more desirably at least 90% recovery. Additionally, the composite exhibits a minimum compression of about 1 mm and recovery of at least about 90% with a 10 kPa load utilizing a compression test to be described later herein.

The composite may be utilized in a number of applications, including, but not limited to, shoe tongue, a shoulder pad, shoe quarter, shoe upper component, knee pad, elbow pad, or the like.

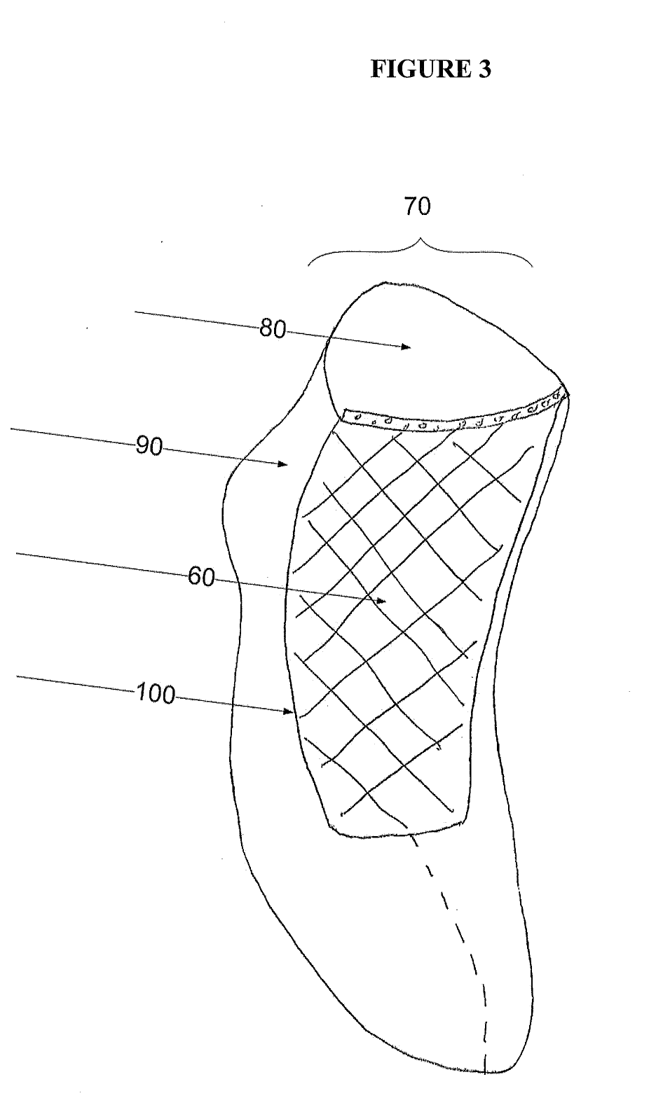

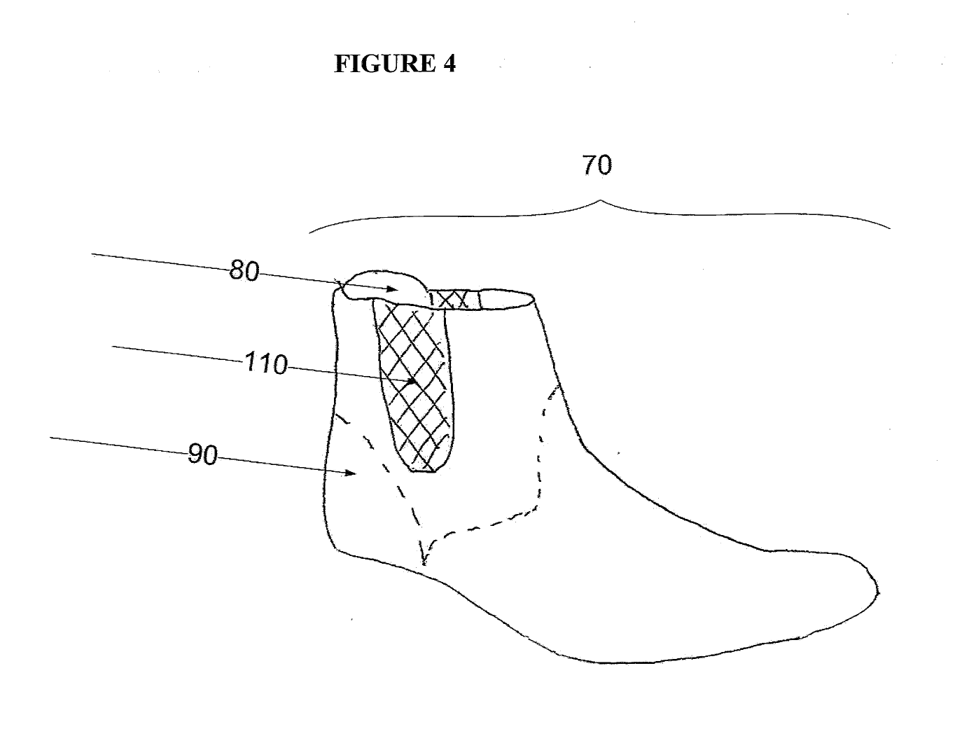

Turning to FIGS. 3 and 4, when the composite 20 is utilized as a shoe tongue 60 or within a shoe quarter section 110, it may be utilized in a footwear assembly 70, otherwise known as a bootie by those skilled in the art of footwear manufacturing.

The footwear assembly 70 contains an opening 80 for inserting the foot therein and includes a peripheral construction 90 constituting a major portion thereof and a tongue portion 60 that projects over the opening 80 and is attached to the peripheral portion. Seams 100, or other suitable means of attachment known in the art, may be utilized to join the peripheral construction 90 with the tongue portion 60 to form the footwear assembly laminate liner material into the general corresponding shape of a shoe upper as known in the art. Seams may also be used when the composite 20 is alternatively utilized in a shoe quarter section 110. The tongue may include the composite 10 materials previously described herein and further illustrated in the examples below. The peripheral construction 90 may be one piece of materials or may include several pieces of material that can be joined together by sewing, welding, gluing, etc. When pieces of the peripheral construction liner are sewn together, the seams can be made waterproof by sealing the seams with known sealing materials, such as GORE-SEAM® tape (available from W. L. Gore and Associates, Inc.). Other sealants may be applied to the seams to render them waterproof if they are not inherently waterproof due to welding or gluing. The peripheral construction 90 includes at least one layer of material which is waterproof and water vapor permeable (i.e., a functional material), such as a breathable polymeric membrane, or film.

Breathable polymeric membranes may be breathable by virtue of pores in the membrane or through a solution diffusion mechanism. Breathable polymeric membranes may be selected from polyurethane, polyester, polyether, polyamide, polyacrylate, copolyether ester and copolyether amides. In an aspect of the invention the waterproof, water vapor permeable membrane is a membrane of microporous polytetrafluoroethylene. In a further aspect of the invention, the microporous polytetrafluoroethylene membrane is a membrane of expanded polytetrafluoroethylene as taught in U.S. Pat. Nos. 3,953,566 and 4,187,390, to Gore. Such membranes of expanded polytetrafluoroethylene are commercially available from W. L. Gore and Associates, Inc., Elkton, Md., under the tradename GORE-TEX® fabric.

The peripheral construction will contain at least the above described functional material. Optionally, it may also contain at least one other material laminated thereto. In this regard, the peripheral construction can include the functional material and a textile material laminated or otherwise joined to at least one side, and often times joined to both sides thereof. Lamination is generally carried out with the use of a discontinuous pattern of suitable adhesive. Thus, water vapor permeability is not significantly affected. At least one other material can be a textile fabric. Textile fabrics can be woven, knit, mesh, nonwoven, felt constructions, etc. Textiles can be produced from natural fibers such as cotton, or from synthetic fibers such as polyesters, polyamides, polypropylenes, polyolefins, or blends thereof. In an aspect of the invention a textile fabric is laminated to the side of the functional material which will be in contact with the upper material. In a further aspect of the invention a textile fabric is laminated to the side of the functional material which will face the inside of the footwear. In a still further aspect of the invention, textile fabric is laminated to both sides.

### Test Methods

### Moisture Vapor Transmission Rate Test (MVTR)

The moisture vapor transmission rate for each sample was determined in accordance with ISO 15496 except that the sample water vapor transmission (WVP) was converted into MVTR moisture vapor transmission rate (MVTR) based on the apparatus water vapor transmission (WVPapp) and using the following conversion.

MVTR=(Delta P value*24)/((1/WVP)+(1+WVPapp value)))

Additionally, the standard specifies a cup diameter of between 85 and 95 mm, but a 64 mm cup diameter was used. Further, sodium chloride was substituted for potassium acetate.

### Elongation and Recovery Test

ASTM test method D 5035-06 “Standard Test Method for Breaking Force and Elongation of Textile Fabrics (Strip Method)” was used to measure elongation and recovery of the stretch laminate test specimens. Test specimens 1″ wide×6″ long were cut along the warp direction. Elongation was measured using an Instron® machine using a gauge length of 4″. Elongation was defined as percent (%) increase in gauge length upon application of a force; measurements were recorded at 4 lbf. Calculation of % recovery was performed after removing the load, using equation given below.

% Recovery=100−[(Final Length−Initial Length)*100/Initial Length]

### Compression and Recovery Test

A circular sample of each finished composite approximately 100 mm in diameter is provided. Sample thickness is measured with a load 29 Pa (t₀) and then the sample is compressed for 5 minutes. The compressed thickness t_{c} will be measured at time=5 minutes. The reported compression is t₀−t_{c}

With regard to recover, after the sample has been compressed for 5 minutes, the load will be removed and final thickness (t_{f}) will be measured with a load of 29 Pa. Compression recovery is (t₀−t_{f})/t₀.

### Whole Boot Moisture Vapor Transmission Rate Test

The Whole Boot Moisture Vapor Transmission Rate for each sample was determined in accordance with Department of Defense Army Combat Boot Temperate Weather Specifications. The specifications are as follows:

4.5.4 Whole boot breathability. The boot breathability test shall be designed to indicate the Moisture Vapor Transmission Rate (MVTR) through the boot by means of a difference in concentration of moisture vapor between the interior and the exterior environment.

### 4.5.4.1 Apparatus.

a. The external test environment control system shall be capable of maintaining 23 (±1) C and 50%±2% relative humidity throughout the test duration.
b. The weight scale shall be capable of determining weight of boots filled with water to an accuracy of (±0.01) gram.
c. The water holding bag shall be flexible so that it can be inserted into the boot and conform to the interior contours; it must be thin enough so that folds do not create air gaps; it must have much higher MVTR than the footwear product to be tested; and it must be waterproof so that only moisture vapor contacts the interior of the footwear product rather than liquid water.
d. The internal heater for the boot shall be capable of controlling the temperature of the liquid water uniformly in the boot to 35 (±1) C.
e. The boot plug shall be impervious to both liquid water and water vapor.

### 4.5.4.2 Procedure.

a. Place boot in test environment,
b. Insert holding bag into boot opening and fill with water to a height of 12.5 cm (5 in) measured from inside sole.
c. Insert water heater and seal opening with boot plug.
d. Heat water in boot to 35 C.
e. Weigh boot sample and record as Wi.
f. Hold temperature in boot after weighing for a minimum of 6 hours.
g. After 6 hours, reweigh boot sample. Record weight as Wf and test duration as Td.
h. Compute whole boot MVTR in grams/hour from the equation below:

MVTR=(Wi−Wf)/Td

4.5.4.3 Method of Inspection. Each boot shall be tested in accordance with the method described in paragraph 4.5.4.2. The average whole boot MVTR from the 5 boots tested shall be greater than 3.5 grams/hour to satisfy the breathability standard.

### Example 1

This example demonstrates a five layer composite having two 2-layer composites joined with a foam layer to create the five layer composite. In the first step, the first composite was produced. The first composite was composed of a sample of polyurethane coated microporous expanded polytetrafluoroethylene film made substantially according to the teachings of U.S. Pat. No. 4,194,041 and U.S. Pat. No. 4,942,214 assigned to W.L. Gore and Associates, Inc, in Elkton, Md. and a stretch recoverable Raschel knit, containing lycra, available from Milliken Co, Spartanburg, S.C. (style #757579) having a weight of about 1.8 oz/yd² with a maximum elongation of about 223% and recovery of about 75% according to manufacture specifications. The stretch recoverable knit was stretched to approximately 90% of its maximum elongation. While the stretch recoverable knit was stretched, the ePTFE film was bonded together with it utilizing a moisture cure adhesive made substantially in accordance with U.S. Pat. No. 4,532,316 to Henn. The adhesive was applied using a gravure roll with 800 micrometer dot spacing and 12% adhesive coverage. The composite was allowed to relax after 48 hours.

In the second step, the second 2-layer composite was composed of a sample of polyurethane coated microporous expanded polytetrafluoroethylene film made substantially according to the teachings of U.S. Pat. No. 4,194,041 and U.S. Pat. No. 4,942,214 assigned to W.L. Gore and Associates, Inc, in Elkton, Md. and a stretch recoverable Raschel knit, containing lycra, available from Milliken Co, Spartanburg, S.C. (style #757579) having a weight of about 5.5 oz/yd² with a maximum elongation of about 231% and recovery of 93% according to manufacturing specification. The stretch recoverable knit was stretched to approximately 90% of its maximum elongation. While the stretch recoverable knit was stretched, the ePTFE film was bonded together with it utilizing a moisture cure adhesive made substantially in accordance with U.S. Pat. No. 4,532,316 to Henn. The adhesive was applied using a gravure roll with 800 micrometer dot spacing and 12% adhesive coverage. The composite was allowed to relax after 48 hours.

In the third step, the first two layer composite was held under minimal tension against the gravure roll by a low durometer rubber roller at 50 psi pressure to print adhesive dots onto its surface. The second two layer composite was also held under minimal tension against the gravure roll by a low durometer rubber roller at 50 psi pressure to print adhesive dots onto its surface. The printed surfaces of the two layers were then bonded to opposite sides of a foam, an ether based polyurethane foam available from FXI (Fort Wayne, Ind.), part number EZ93A, 4 mm thickness, which was prestretched to about 100% of its original length. The composite was then heat cured with heat-curable polyurethane adhesive.

### Example 2

This example demonstrates a four layer composite. The four layer composite was made in accordance with the process described in Example 1, with the following exceptions. Textile layers are only stretched with minimal tension. That is, the textile layers are stretched in an amount insufficient for macroscopic stretching, for example less than 5%. The first two layer composite was composed of a weft stretch knit (50% nomex, 50% modacrylic circle knit) having a weight of about 2.6 oz/sq. yard and a weft stretch low transverse strength microporous ePTFE made substantially in accordance with the teachings for U.S. Pat. No. 4,532,316 to Henn. The second two layer composite is only composed of one layer, a weft stretch knit (50% nomex, 50% modacrylic circle knit) having a weight of about 2.6 oz/sq. yard. The foam layer is Example 1 and 2 are the same.

### Example 3

This example demonstrates a five layer composite. The five layer composite was made substantially in accordance with the process described in Example 1, with the following exceptions. The first two layer composite was composed of a stretch woven containing Lycra (3.8 oz/sq. yard, 21% bright nylon, 59% high tenacity nylon, 20% spandex, part number 532A available from Tweave, Inc. Norton, Mass.). The PTFE film was the same. The foam utilized in the third step was a 4 mm ester based polyurethane foam (Z65CLB from FXI in Fort Wayne, Ind.).

### Example 4

This example demonstrates a four layer composite. The four layer composite was made substantially in accordance with the process described in Example 1, with the following exceptions. The second two layer only has one layer, the astretch recoverable Raschel knit, containing lycra described in Example 1 and does not contain an additional film layer. Additionally, the form utilized in the third step does not contain adhesive on either side.

### Comparative Example 1

A sample, approximately 3″ by 6″, was cut form a Ridgeline MT Boot (Bogs style number 52182, Portland, Oreg.). This is believed to be the material described in the patent publication US 2010/0024254 to Coombs. The sample was composed of woven fabric, perforated synthetic rubber, 4 way stretch air permeable membrane, stretchable deformable material, and woven fabric.

### Example 5

This example demonstrates a two layer composite. The composite was composed of a sample of polyurethane coated microporous expanded polytetrafluoroethylene film made substantially according to the teachings of U.S. Pat. No. 4,194,041 and U.S. Pat. No. 4,942,214 assigned to W.L. Gore and Associates, Inc, in Elkton, Md. and a foam, an ether based polyurethane foam (EZ93A available from FXI in Fort Wayne, Ind.) 4 mm thickness which was prestretched to about 100% of its original length. The PTFE film was bonded together with the foam utilizing a moisture cure adhesive made substantially in accordance with U.S. Pat. No. 4,532,316 to Henn. The adhesive was applied using a gravure roll with 800 micrometer dot spacing and 12% adhesive coverage.

### Example 6

This example demonstrates a two layer composite. The composite was composed of a sample of a weft stretch low transverse strength microporous ePTFE made substantially in accordance with the teachings for U.S. Pat. No. 4,532,316 to Henn, and a 4 mm ester based polyurethane foam (Z65CLB from FXI in Fort Wayne, Ind.) under minimal tension. The film was bonded together with the foam utilizing a moisture cure adhesive made substantially in accordance with U.S. Pat. No. 4,532,316 to Henn. The adhesive was applied using a gravure roll with 800 micrometer dot spacing and 12% adhesive coverage.

### Test Results

### MVTR Results:

| Material | MVTR (g/m\hat{ }2/24 hrs) |
|---|---|
| Example 1 | 1194 |
| Example 2 | 1240 |
| Example 3 | 1396 |
| Example 4 | 1571 |
| Comparative Example | −87 |
| Example 5 | 2293 |
| Example 6 | 1694 |

Elongation greater than 35% at 4 lbf on ASTM 5035-06

### Elongation Results:

| Material | Strain @ 4 lbf with 1″ wide specimen |
|---|---|
| Example 1 | 83% |
| Example 2 | 52% |
| Example 3 | 47% |
| Example 4 | 90% |
| Comparative Example | 21% |
| Example 5 | 97% |
| Example 6 | 114% |

Greater than 80% recovery on ASTM 5035-06

### Stretch Recovery Results:

| | Change in length after load of 4 lbf with 1″ |
|---|---|
| Material | wide specimen |
| Example 1 | 98% |
| Example 2 | 99% |
| Example 3 | 94% |
| Example 4 | 90% |
| Comparative Example | 96% |
| Example 5 | 92% |
| Example 6 | 83% |

### Compression Results:

| Material | Compression with 9 kPa load (mm) |
|---|---|
| Example 1 | 2.77 |
| Example 2 | 3.56 |
| Example 3 | 1.28 |
| Example 4 | 2.88 |
| Comparative Example | 3.43 |
| Example 5 | 3.12 |
| Example 6 | 3.79 |

### Compression Recovery Results:

| Material | Percent recovery (%) |
|---|---|
| Example 1 | 95 |
| Example 2 | 96 |
| Example 3 | 93 |
| Example 4 | 96 |
| Comparative Example | 98 |
| Example 5 | 96 |
| Example 6 | 97 |

### Whole Boot MVTR Test Results

Boots integrating the footwear assembly were made with 1000 Denier nylon and flesh-out waterproof leather and waterproof bootie in the style of the United States Army Infantry Combat Boot as described in the solicitation for Temperate Weather Army Combat Boot, GL-PD-08-10. The boots, modeled after the Belleville 790 (Belleville Shoe, Belleville, Ill.), described herein were tested utilizing the Whole Boot Moisture Vapor Transmission Test described earlier herein. Additionally, comparative Example 1, which is a gussetless boot with a separate padded “floating” tongue manufactured substantially according to the teaching of EP 0927 524 to Poloniato was created. Comparative Example 2, is a boot containing no padding and is gusseted. It was manufactured substantially in accordance with Sacre, U.S. Pat. No. 4,599,810.

### Whole Boot MVTR

| Boot Construction | Whole Boot MVTR (US Mil. Test) (g/hr) |
|---|---|
| Example 1 | 7.4 |
| Comparative Example 1 | 4.9 |
| Comparative Example 2 | 6.8 |

1. A waterproof, breathable stretch recoverable composite comprising:
A. a first layer comprising a waterproof breathable film;
B. a second layer comprising a breathable padding material attached to the first layer,
wherein the composite is stretchable in at least one direction by at least about 35% at 4 lbs force and exhibit at least about 80% recovery, further wherein the composite exhibits a minimum compression of about 1 mm under a 10 kPa load and recovery of at least about 90% when load is removed.

2. The composite of claim 1, breathable padding material comprises foam.

3. The composite of claim 1, wherein the breathable padding material comprises fleece.

4. The composite of claim 1, wherein the breathable padding material comprises three dimensional knit or nonwoven material.

5. The composite of claim 1, wherein the film comprises a polymeric film.

6. The composite of claim 5, wherein the polymeric film comprises expanded polytetrafluorethylene.

7. The composite of claim 5, wherein the polymeric film comprises a thermoplastic film.

8. The composite of claim 5, wherein the polymeric film comprises an elastomeric film.

9. The composite of claim 5, wherein the polymeric film comprises polyurethane, polyester, polyether, polyamide, polyacrylate, copolyether ester and copolyether amides.

10. The composite of claim 1, further comprising one or more textile layers.

11. The composite of claim 1, wherein the composite comprises a breathability of at least about 600 g/m²/day.

12. The composite of claim 1, wherein the composite is stretchable in at least one direction by at least about 50% at 4 lbs force and exhibits at least about 90% recovery

13. The composite of claim 1, comprising at least one additional waterproof breathable film.

14. A shoe tongue comprising the composite of claim 1.

15. The shoe tongue of claim 14 incorporated into a footwear assembly, wherein the footwear assembly is substantially gussettless.

16. A shoulder pad, glove, bike short, bootie, shoe quarter, shoe upper component, knee pad, or elbow pad comprising the composite of claim 1.

17. A footwear assembly for forming at least a part of footwear, the footwear assembly comprising:
A. a first peripheral construction adapted to surround at least a portion of a foot; and
B. a composite comprising a tongue construction which projects over an opening of the footwear adapted for insertion of a foot, the tongue construction comprising a first layer comprising a waterproof breathable film and a second layer comprising a breathable padding material attached to the first layer,
wherein the tongue construction is connected with the first peripheral construction.

18. The footwear assembly of claim 17, wherein the composite is stretchable in at least one direction by at least about 35% at 4 lbs force and exhibits at least about 80% recovery, further wherein the composite exhibits a minimum compression of about 1 mm under a 10 kPa load and recovery of at least about 90% when load is removed

19. The footwear assembly of claim 18, wherein the composite is stretchable in at least one direction by at least about 50% at 4 lbs force and exhibits at least about 90% recovery

20. The footwear assembly of claim 17, wherein the breathable padding material comprises foam.

21. The footwear assembly of claim 17, wherein the breathable padding material comprises fleece

22. The footwear assembly of claim 17, wherein the breathable padding material comprises nonwoven material or three dimensional knit.

23. The footwear assembly of claim 17, wherein the waterproof, breathable film comprises a polymeric film.

24. The footwear assembly of claim 23, wherein the polymeric film comprises expanded polytetrafluorethylene.

25. The footwear assembly of claim 23, wherein the polymeric film comprises a thermoplastic film.

26. The footwear assembly of claim 23, wherein the polymeric film comprises an elastomeric film.

27. The footwear assembly of claim 17, wherein the tongue construction comprises a breathability of at least about 600 g/m²/day.

28. The footwear assembly of claim 17, further comprising one or more textile layers.

29. The footwear assembly of claim 17, wherein the tongue construction is connected with the peripheral construction utilizing a stitched seam.

30. The footwear assembly of claim 17, wherein the tongue construction is connected with the peripheral construction utilizing an adhesive.

31. The footwear assembly of claim 17, wherein the breathable padding material is arranged on a surface of the waterproof breathable film facing towards an inside surface of the footwear.

32. The footwear assembly of claim 17, wherein the breathable padding material further comprises a backing layer arranged on a surface of the waterproof breathable film facing outside of the footwear.

33. The footwear assembly of claim 17, wherein the breathable padding material further comprises a backing layer arranged on a surface of the waterproof breathable film facing outside of the footwear, and a lining layer facing towards an inside of the footwear, wherein the waterproof breathable film is disposed between the backing layer and lining layer.

34. The footwear assembly of claim 17, wherein, in use, the composite is substantially gussettless.

35. The footwear assembly of claim 23, wherein the polymeric film comprises polyurethane.

36. A footwear assembly for forming at least a part of footwear, the footwear assembly comprising:
a first peripheral construction comprising one or more sections and adapted to surround at least a portion of a foot, wherein at least one section of the first peripheral construction comprises a composite comprising a first layer comprising a waterproof breathable film and a second layer comprising a breathable padding material attached to the first layer.
